(19) United States
(12) Patent Application Publication
(10) Pub. No.: US 2024/0229243 A1
(43) Pub. Date: Jul. 11, 2024

(54) NON-CR PASSIVATING COMPOSITION AND ARTICLE TREATED BY THE SAME

(71) Applicant: CHEMETALL GMBH, Frankfurt (DE)

(72) Inventors: Jia Yun YANG, Shanghai (CN); Ling Ling ZHU, Shanghai (CN); Hai Xia ZOU, Shanghai (CN); Sheng Xing WAN, Shanghai (CN)

(21) Appl. No.: 18/560,007

(22) PCT Filed: May 24, 2022
(86) PCT No.: PCT/EP22/64079

§ 371 Date: Nov. 9, 2023

(30) Foreign Application Priority Data
May 27, 2021 (WO) PCT/CN2021/096348

(51) Int. Cl. C23C 22/05; C09D 5/08; C09D 133/08; C09D 175/04

(52) U.S. Cl. CPC C23C 22/05; C09D 5/08; C09D 133/08; C09D 175/04; C23C 2222/20

(57) ABSTRACT

Disclosed herein is an aqueous non-Cr passivating composition including, on the basis of the weight of the non-Cr passivating composition: (a) 5 to 20% by weight of a silicon-containing compound; and (b) 5 to 15% by weight of a water-borne polymer, which is selected from the group consisting of a polyurethane resin, an epoxy resin, a polyacrylate resin and the combination thereof. Further disclosed herein are a metal with a surface passivated by the aqueous non-Cr passivating composition and an article having a metallic surface passivated by the aqueous non-Cr passivating composition, and a process for passivating a metallic surface with the aqueous non-Cr passivating composition.

### TECHNICAL FIELD

The present invention relates to an aqueous non-Cr passivating composition. The present invention further relates to an article treated by the aqueous non-Cr passivating composition. The present invention also relates to a process of passivating a metallic surface by the aqueous non-Cr passivating composition.

### BACKGROUND

Materials with a non-Cr passivation layer (Non-Cr passivated materials) are widely used in various industries. For example, in home-appliance industry, they are used for both interior and exterior parts due to their good formability, corrosion resistance and appearance. The exterior parts of home-appliance, especially those used outdoor, need to be painted with a protection layer over the passivation layer. Normally the protection layer is formed via polyester-based powder or solvent-borne coatings, and the thickness of the formed protection layer is around 60-80 μm. The excellent adhesion between the passivation layer and the protection layer is of great importance. Higher surface energy of a passivation layer means a better repaintability. When the surface energy reaches 40 dyne/cm, the passivation layer could have good repaintability with most powder and solvent-borne coatings. To increase the surface energy of a passivation layer, several methods are tried in recent years, such as adding surfactants to passivating compositions. It is expected that such surfactants having polar groups can migrate to the surface of the formed passivation layer to increase surface energy.

One example of such surfactants is polyether-modified polyacrylates, such as BYK-3560, BYK-3565 from BYK Chemie. After a surfactant-added non-Cr passivating composition is applied, the polyether-modified polyacrylates will migrate to the surface of the layer during curing process because of its low compatibility with other components in the composition. It is expected that such polyether-modified polyacrylates concentrated on the surface of the passivation layer will increase surface energy.

However, the effect of such polyether-modified polyacrylates mostly relies on its low compatibility, which quite limits their applications. In addition, shrinkage may occur in the wet passivation layer, and during and after drying of the passivation layer, it will release irritating odors. Also, such low compatibility will shorten the shelf life of the composition.

Another example of surfactants is wax having polar groups such as natural carnauba wax or montan wax having lots of carboxyl and/or hydroxyl groups that could increase surface energy. However, the use of such waxes is seriously limited because of their low melting points (about 80° ° C. at one atm.).

A further example of surfactants is hydrophilic blocked polyisocyanates with a deblocking temperature of from 90° C. to 110° C. With a proper drying temperature, it will deblock and release isocyanate groups that will increase surface energy of the formed passivation layer.

However, such hydrophilic blocked polyisocyanate may impair resistance of the formed passivation layer against boiling water, and meanwhile its high cost is also a concern. Furthermore, almost all development work in the art for non-Cr passivation layers with high surface energy is based on acidic systems having a pH value in a range of 3 to 5. But for many applications, passivated articles such as passivated strips are pretreated by a degreasing agent having a pH value in a range of 12 to 13. The gap in pH value leads to a decreased adhesion of the passivation layers to the articles.

Therefore, it is still required to develop a non-Cr passivating composition which could form a passivation layer having a high surface energy and good resistances against corrosion, solvent, boiling water, heat and darkening etc.

### SUMMARY OF THE INVENTION

In one aspect, the present invention provides an aqueous non-Cr passivating composition. The aqueous non-Cr passivating composition comprises:
(a) a silicon-containing compound; and
(b) a water-borne polymer selected from a group consisting of polyurethane resin, epoxy resin, polyacrylate resin or the combination thereof.

In another aspect, the present invention provides a passivation layer obtained from the aqueous non-Cr passivating composition of the present invention.

In another aspect, the present invention provides a metal with a surface passivated by the invented aqueous non-Cr passivating composition.

In another aspect, the present invention provides an article with a metallic surface passivated by the invented aqueous non-Cr passivating composition.

In another aspect, the present invention provides a process of passivating a metallic surface comprising a step of applying the invented aqueous non-Cr passivating composition onto the metallic surface.

It is surprisingly found that the non-Cr passivating composition of present invention has several advantages such as offering good storage stability and enabling high surface energy of the passivation layer. Moreover, the obtained passivation layers have excellent properties such as good resistance against corrosion, solvent, boiling water, heat and darkening etc.

### DETAILED DESCRIPTION OF THE INVENTION

The present invention now will be described more fully hereinafter, in which some, but not all embodiments of the invention are shown. Indeed, this invention can be embodied in many different forms and should not be construed as limited to the embodiments set forth herein; rather, these embodiments are provided so that this disclosure will satisfy applicable legal requirements.

In the present disclosure, expressions “a”, “an”, “the”, when used to define a term, include both the plural and singular forms of the term.

The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates, if used, may be embraced within “comprises” or cognates.

The term “article” means an article made of a metal or an article having a metallic surface.

The term “metallic surface” means a surface of a metal or a surface made of a metal.

The term “passivation layer” means a film obtained from curing or drying a passivating composition.

The term “silane” means silane and its hydrolysis, condensation, polymerization and reaction products in particular silanols, siloxanes and polysiloxanes.

The term “polysiloxane” means polysiloxane and its condensation, polymerization and reaction products of polysiloxane.

The term “water-borne polymer” means a polymer that is dispersible or soluble in water or any aqueous medium.

The term “polyurethane” means a polymer composed of a chain of organic units joined by carbamate (urethane) links. Polyurethane resins are formed by reacting a monomer having two or more isocyanate (—N═C═O) groups with a monomer having two or more hydroxyl (—OH) groups.

The term “isocyanate”, “diisocyanate” or “polyisocyanate” means a compound having one, two or at least three isocyanate (—N═C═O) groups respectively.

The term “polyacrylate resin” is a general name for acrylic polymer and methacrylic polymer (or (meth)acrylate polymer) and the derivatives thereof.

The term “(meth)acrylate” means acrylate and/or methacrylate monomer.

All percentages and ratios regarding the composition are mentioned by weight unless otherwise indicated.

### (a) Silicon-Containing Compound

Component (a) of the invented aqueous non-Cr passivating composition is a silicon-containing compound.

Silicon-containing compounds in the art capable of forming films can be used in the invented aqueous non-Cr passivating composition as component (a).

Component (a) may be selected from a group consisting of silanes. For examples, silanes used in the present invention can be selected from acyloxysilane, alkyl silane, alkyl trialkoxysilane, aminosilane, aminoalkyl silane, aminopropyl trialkoxysilane, bis-silyl silane, epoxysilane, fluoroalkyl silane, glycidoxysilane such as glycidoxyalkyl trialkoxysilane, isocyanato silane, mercapto silane, (meth)acrylato silane, monosilyl silane, polysilyl silane, bis-(trialkoxysilylpropyl)amine, bis-(trialkoxysilyl)ethane, sulfur-containing silane, bis-(trialkoxysilyl)propyltetrasulfane, ureidosilane such as (ureidopropyltrialkoxy)silane, vinyl silane, in particular vinyltrialkoxysilane or/and vinyltriacetoxysilane, or/and at least one corresponding silanol or/and siloxane.

Preferably, said silane could be selected from a group consisting of tetraethoxysilane, 3-glycidoxyalkyltrialkoxysilane, 3-methacryloxyalkyltrialkoxysilane, aminoalkylaminoalkylalkyldialkoxysilane, β-(3,4-epoxycycloalkyl) alkyltrialkoxysilane, (3,4-epoxycycloalkyl) alkyltrialkoxysilane, bis(trialkoxysilylalkyl) amine, bis-(trialkoxysilyl) ethane, (3,4-epoxyalkyl) trialkoxysilane, γ-aminoalkyl trialkoxysilane, γ-methacryloxyalkyltrialkoxysilane, γ-ureidoalkyltrialkoxysilane, glycidoxyalkyltrialkoxysilane, N-(3-(trialkoxysilyl) alkyl) alkylenediamine, N-β-(aminoalkyl)-γ-aminoalkyltrialkoxysilane, N-(γ-trialkoxysilylalkyl) dialkylenetriamine, polyaminoalkylalkyldialkoxysilane, tris(3-(trialkoxysilyl) alkyl) isocyanurate, (ureidopropyltrialkoxy) silane and vinyltriacetoxysilane. More preferably, said silane could be selected from a group consisting of 3-aminopropyl triethoxysilane, 3-epoxypropyl trimethoxysilane, tetraethoxysilane and 3-vinyl trimethoxysilane.

Component (a) may also be selected from a group consisting of silica sols. In an embodiment of the invention, the silica sol is used in a form of a dispersion having a concentration of from 10% to 50% by weight based on the total weight of the dispersion. Generally, the particle diameters of the silica sol particles fall in the range of from 5 nm to 100 nm. When silica sol is used as component (a), its amount is calculated based on dry content.

In an embodiment of the invention, the aqueous non-Cr passivating composition comprises both silane and silica sol as component (a).

In the aqueous non-Cr passivating composition, component (a) is presented in an amount of from 5% to 20% by weight, and preferably from 8% to 15%, based on the total weight of the composition.

### (b) Water-Borne Polymer

The aqueous non-Cr passivating composition of the present invention comprises a water-borne polymer as component (b) and said water-borne polymer is at least one selected from a group consisting of polyurethane resin, epoxy resin and polyacrylate resin.

In said aqueous non-Cr passivating composition, the amount of component (b) is in a range of from 5% to 15% by weight, based on the total weight of the composition. For example, the amount of component (b) in said aqueous non-Cr passivating composition is in a range of from 5% to 10% by weight, based on the total weight of the aqueous non-Cr passivating composition.

It has been found that as component (b) of said aqueous non-Cr passivating composition, combinations of resins used as component (b) could help preparing passivation layers having good properties.

In a preferred embodiment of the present invention, component (b) of the aqueous non-Cr passivating composition is a combination of polyurethane resin and polyacrylate resin. It is surprisingly found that by combining polyurethane resin and polyacrylate resin used as component (b) of the aqueous non-Cr passivating composition, the surface energy of the formed passivation layer could be increased dramatically and at the same time storage stability of the composition as well as resistance of the passivation layers against corrosion, chemicals, boiling-water, darkening and heat are improved significantly. In a preferred embodiment, the ratio by weight of polyurethane resin to polyacrylate resin is in a range of from 0.5 to 1.2, preferably in a range of from 0.6 to 1.0, more preferably from 0.7 to 1.0.

### Polyurethane Resin

Polyurethane resin suitable for said aqueous non-Cr passivating composition could be any water-borne polyurethane resin known in the art capable of forming a film.

Polyurethane resins suitable for the aqueous non-Cr passivating composition of the present invention can be prepared by reacting at least one polyol selected from a group consisting of polyester polyols and polyether polyols with di- or polyisocyanate.

Appropriate isocyanates can be selected by persons skilled in the art. For example, the isocyanate could be hexamethylene diisocyanate, octamethylene diisocyanate, decamethylene diisocyanate, dodecamethylene diisocyanate, tetradecamethylene diisocyanate, trimethylhexane diisocyanate, tetramethylhexane diisocyanate, isophorone diisocyanate, 2-isocyanatopropylcyclohexyl isocyanate, dicyclohexylmethane 2,4′-diisocyanate, dicyclohexylmethane 4,4′-diisocyanate, 1,4- or 1,3-bis(isocyanatomethyl)cyclohexane, 1,4- or 1,3- or 1,2-diisocyanatocyclohexane, 2,4- or 2,6-diisocyanato-1-methylcyclo-hexane, diisocyanates derived from dimer fatty acids, as DDI 1410 from Henkel, 1,8-diisocyanato-4-isocyanato-methyloctane, 1,7-diisocyanato-4-isocyanatomethylheptane, 1-isocyanato-2-(3-isocyanatopropyl)cyclohexane, tetramethylxylylene diisocyanates (TMXDI), or mixtures of these polyisocyanates. In some embodiments, the isocyanate could be tetramethylxylylene diisocyanates (TMXDI) or isophorone diisocyanate or their combination. In some embodiments, the isocyanate is isophorone diisocyanate.

Preferably, the polyurethane resin in said aqueous non-Cr passivating composition excludes aromatic structure.

The polyurethane resin could be added into said aqueous non-Cr passivating composition in a dispersion form. For example, said dispersion may be selected from a group consisting of Siwo

®PUD1917 (Shanghai Sisheng Polymer Materials Co. Ltd.); ALBERDINGK® CUD4820 VP and ALBERDINGK® CUD4835 VP (Alberdingk Boley); ESACOTE®PUC1 (Lamberti Asia Pacific Limited); DIC® HYDRAN MC1030, DIC®HYDRAN CP-7520, and DIC®HYDRAN CP-7050 (DIC Corporation). And the amount of polyurethane resin is calculated based on the polyurethane resin in the dispersion when it is added into the aqueous non-Cr passivating composition in a dispersion form.

### Epoxy Resin

Epoxy resin suitable for said aqueous non-Cr passivating composition could be any water-borne epoxy resin known in the art capable of forming a film.

Persons skilled in the art can select appropriate epoxy resins for the present invention. For example, the epoxy resins could be selected from a group consisting of bisphenol A type epoxy resins, bisphenol F type epoxy resins, glycidyl ether epoxy resins such as polyphenol type glycidyl ether epoxy resins, glycidyl ester epoxy resins, silicone-modified epoxy resins, and polyurethane modified epoxy resins.

### Polyacrylate Resin

Polyacrylate resins known in the art capable of forming a film could be used in the present invention.

The polyacrylate resin could be added into said aqueous non-Cr passivating composition in a dispersion or emulsion form. And the amount of the polyacrylate resin is calculated based on the polyacrylate resin in the dispersion or emulsion when it is added into said aqueous non-Cr passivating composition in a dispersion or emulsion form.

Preferably, polyacrylate resins used as component (b) are prepared from emulsion polymerization of monomers in the presence of polymerization initiating agents.

It is surprisingly found that the polyacrylate resin prepared from emulsion polymerization and having appropriate number average molecular weight (Mn) and average particle diameter will help to improve the alkali resistance of the formed passivation layer.

Preferably, the polyacrylate resin has a number average molecular weight (Mn) in a range of from 100,000 Dalton to 500,000 Dalton, determined by gel permeation chromatography (GPC) according to DIN 55672-1. Preferably, the polyacrylate resin has a number average molecular weight in a range of from 100,000 Dalton to 300,000 Dalton, and more preferably in a range of from 100,000 Dalton to 200,000 Dalton.

Preferably, the polyacrylate resin has a particle diameter in a range of from 50 to 400 nm, preferably in a range of from 100 to 300 nm, and more preferably from 100 to 200 nm, measured by DLS (dynamic light scattering).

Persons skilled in the art can select appropriate conditions and procedures for the emulsion polymerization according to actual applications. In a preferred embodiment, polyacrylate resins used in the present invention are prepared by emulsion polymerization without using any fluorine-containing emulsifier.

Monomers for preparing polyacrylate resin are known in the art. For example, these monomers could be methyl acrylate, methyl methacrylate, acrylic acid, methacrylic acid, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclohexyl (meth)acrylate, (meth)acrylate esters of alkyl-substituted cyclohexanol, and (meth)acrylate esters of alkanol-substituted cyclohexane, such as 2-tert-butyl and 4-tert-butyl cyclohexyl (meth)acrylate, 4-cyclohexyl-1-butyl (meth)acrylate, and 3,3,5,5,-tetramethyl cyclohexyl (meth)acrylate; isobornyl (meth)acrylate; isomenthyl (meth)acrylate; cyclopentyl (meth)acrylate, (meth)acrylate esters of alkyl-substituted cyclopentanols, and (meth)acrylate esters of alkanol substituted cyclopentanes; adamantanyl (meth)acrylates; cyclododecyl (meth)acrylate; cycloundecanemethyl (meth)acrylate; dicyclohexylmethyl (meth)acrylate; cyclododecanemethyl (meth)acrylate; menthyl (meth)acrylate and their combinations.

For example, the polyacrylate resin dispersion or emulsion could be selected from a group consisting of NeoCryl XK350 (DSM NeoResins); GUANGSHU®GS-406 (Changzhou Guangshu Chemical Technology); Capast®CP 7012 (Caprol Chemical (Shanghai) Co. Ltd.); and Gardobond PC8918 CA (Chemetall).

### (c) Corrosion Inhibitor

Preferably, the aqueous non-Cr passivating composition of the present invention may further comprise a corrosion inhibitor as component (c).

Component (c) in said aqueous non-Cr passivating composition is used to prevent metals from corrosion. Furthermore, component (c) could improve the stability of the aqueous non-Cr passivating composition during storage.

For example, component (c) may be a phosphorus-containing compound selected from a group consisting of organic phosphonic acids, inorganic phosphoric acids, and salts thereof; or an acidic corrosion inhibitor such as fluorine-containing acidic corrosion inhibitors like hexafluorotitanic acid, hexafluorozirconic acid or their combination.

Inorganic phosphoric acid or phosphate is preferably added in at least one form selected from monophosphates (=orthophosphates based on PO₄³⁻, monohydrogen phosphates based on HPO₄²⁻, or dihydrogen phosphates based on H₂PO₄⁻), diphosphates, triphosphates, phosphorus pentoxide and phosphoric acid (=orthophosphoric acid H₃PO₄). Phosphate can be monometallic phosphate, a mixture of phosphoric acid and metal, a mixture of phosphoric acid and metallic salt/oxide, diphosphate, triphosphate, polyphosphate of phosphorus pentoxide etc. In one embodiment, phosphorus-containing compound suitable for the present invention is zinc dihydrogen phosphate.

Organic phosphonic acids and salts could be added as component (c) into said aqueous non-Cr passivating composition. Said organic phosphonic acids and salts suitable for the present invention may comprise but are not limited to diphosphonic acid and diphosphonic acid having an alkyl chain. For example, 1-hydroxyethane-1,1-diphosphonic acid (HEDP), aminotris(methylenephosphonic acid) (ATMP), ethylenediamine-tetra(methylenephosphonic acid) (EDTMP), diethylenetriamine-penta-(methylenephosphonic acid) (DTPMP), diethylenetriamine-penta(methylenephosphonic acid) (DTPMP), hexamethylenediamine-tetra(methylenephosphonic acid) (HDTMP), hydroxyethyl-amino-di(methylenephosphonic acid) (HEMPA) or/and phosphonobutane-1,2,4-tricarboxylic acid (PBTC).

The amount of component (c) in said aqueous non-Cr passivating composition is in a range of from 1% to 10% by weight, for example in a range of from 1% to 5% by weight, based on the total weight of the aqueous non-Cr passivating composition.

### (d) Additive

The aqueous non-Cr passivating composition of the present invention may further comprise at least one additive.

Persons skilled in the art could select one or more additives used in the aqueous non-Cr passivating composition of the present invention according to actual applications. For example, these additives could be defoaming agents, such as BYK028 (BYK Chemie); humectants, such as SF 104E (Evonik); film-forming aids, such as dipropylene glycol mono butyl ether.

In some embodiments, polyester resins and novolac resin could also be added as additives.

When the additive is added, its amount can be determined by persons skilled in the art. Generally, the amount of the additional additive may be in a range of from 1 to 10% by weight, such as 1 to 5% by weight, based on the total weight of the aqueous non-Cr passivating composition of the present invention.

### Application of the Aqueous Non-Cr Passivating Composition

The aqueous non-Cr passivating composition of the present invention is applicable for passivating metals and metallic surfaces. For example, these metals could be aluminum, iron, copper, magnesium, titanium, zinc, tin and/or their alloys, preferably zinc and steel and hot-dip galvanized (HDG) metals such as hot-dip galvanized (HDG) steel, electrolytically galvanized metals, alloy of electrogalvanized metals and/or alloy of hot-dip galvanized metals.

Furthermore, articles made of metals or having metallic surfaces can be treated with the invented aqueous non-Cr passivating composition as well. For example, the metallic surfaces could be surfaces of aluminum, iron, copper, magnesium, titanium, zinc, tin and/or their alloys, preferably zinc and steel and hot-dip galvanized (HDG) metals such as hot-dip galvanized (HDG) steel, electrolytically galvanized metals, alloy electrogalvanized metals and/or alloy hot-dip galvanized metals. In particular articles having metallic surfaces made from hot-dip galvanized (HDG) metals, such as hot-dip galvanized (HDG) steel, electrolytically galvanized metals, alloy electrogalvanized metals and/or alloy hot-dip galvanized metals, can be treated with the invented aqueous non-Cr passivating composition. Said articles can be wire, strip, sheet, cladding, screening, car body or car body part, part of vehicle, trailer, caravan or flying body, covering, housing, lamp, light, traffic light element, item of furniture or furniture element, element of domestic appliance, frame, profile, formed part with complex geometry, crash barrier element, radiator element or fencing element, bumper, part consisting of or having at least one pipe or/and profile, window, door or bicycle frame, wire winding, wire mesh or small part.

### EMBODIMENTS

Below embodiments further illustrate how this invention could be carried out.

### Embodiment 1

An aqueous non-Cr passivating composition comprising
(a) from 5% to 20%, preferably from 8% to 15%, by weight of a silicon-containing compound; and
(b) from 5% to 15%, preferably from 5% to 10%, by weight of a water-borne polymer selected from a group consisting of polyurethane resin, epoxy resin, polyacrylate resin and the combination thereof, the weight percentage is based on the total weight of the non-Cr passivating composition.

### Embodiment 2

The aqueous non-Cr passivating composition of embodiment 1, wherein said component (b) is a combination of polyurethane resin and polyacrylate resin, preferably, the ratio by weight of polyurethane resin to polyacrylate resin is in a range of from 0.5 to 1.2, and more preferably from 0.6 to 1, such as from 0.7 to 1.

### Embodiment 3

The aqueous non-Cr passivating composition of any one of embodiments 1 to 2, wherein said silicon-containing compound is selected from a group consisting of silanes and silica sols.

### Embodiment 4

The aqueous non-Cr passivating composition of embodiment 3, wherein said silica sol has an average particle diameter in a range of from 5 nm to 100 nm.

### Embodiment 5

The aqueous non-Cr passivating composition of any one of embodiments 3 to 4, wherein said silica sol is in a form of dispersion having a concentrate of from 10% to 50% by weight based on the total weight of the dispersion.

### Embodiment 6

The aqueous non-Cr passivating composition of any one of embodiments 1 to 5, wherein said polyurethane resin does not contain aromatic group.

### Embodiment 7

The aqueous non-Cr passivating composition of any one of embodiments 1 to 6, wherein it further comprises (c): from 1% to 10% by weight, preferably from 1% to 5% by weight of a corrosion inhibitor, the weight percentage is based on the total weight of the non-Cr passivating composition.

### Embodiment 8

The aqueous non-Cr passivating composition of embodiment 7, wherein said corrosion inhibitor is at least one selected from a group consisting of phosphorus-containing compounds and acidic corrosion inhibitors, preferably, said corrosion inhibitor is at least one selected from a group consisting of 1-hydroxyethane-1,1-diphosphonic acid, zinc dihydrogen phosphate, hexafluorotitanic acid and hexafluorozirconic acid.

### Embodiment 9

The aqueous non-Cr passivating composition of any one of embodiments 1 to 8, wherein it further comprises (d): from 1% to 10%, preferably from 1% to 5% by weight of an additive selected from a group consisting of defoaming agent, humectant and film-forming aid.

### Embodiment 10

The aqueous non-Cr passivating composition of any one of embodiments 1 to 9, wherein said polyacrylate resin has a number average molecular weight in the range of from 100,000 Dalton to 500,000 Dalton, determined by gel permeation chromatography according to DIN 55672-1, preferably in the range of from 100,000 Dalton to 300,000 Dalton, such as in the range of from 100,000 Dalton to 200,000 Dalton.

### Embodiment 11

The aqueous non-Cr passivating composition of any one of embodiments 1 to 10, wherein said polyacrylate resin has a particle diameter in a range of from 50 nm to 400 nm, preferably in a range of from 100 nm to 300 nm, such as from 100 nm to 200 nm, measured by dynamic light scattering.

### Embodiment 12

The aqueous non-Cr passivating composition of any one of embodiments 1 to 11, wherein said component (b) is a combination of polyurethane resin and polyacrylate resin, preferably the molar ratio of polyurethane resin to polyacrylate resin is in a range of from 0.5 to 1.2, more preferably in a range of from 0.6 to 1, such as from 0.7 to 1; said polyacrylate resin has a number average molecular weight in a range of from 100,000 Dalton to 500,000 Dalton, determined by gel permeation chromatography according to DIN 55672-1, preferably in a range of from 100,000 Dalton to 300,000 Dalton, such as in a range of from 100,000 Dalton to 200,000 Dalton; and said polyacrylate resin has an average particle diameter in a range of from 50 nm to 400 nm, preferably in a range of from 100 nm to 300 nm, such as from 100 to 200 nm, measured by dynamic light scattering.

### Embodiment 13

The aqueous non-Cr passivating composition of any one of embodiments 1 to 12, wherein said polyacrylate resin is synthesized by emulsion polymerization, preferably by emulsion polymerization without using fluorine-containing emulsifier.

### Embodiment 14

A passivation layer obtained from the aqueous non-Cr passivating composition of any one of embodiments 1 to 13.

### Embodiment 15

A metal with a surface passivated by the aqueous non-Cr passivating composition of any one of embodiments 1 to 13.

### Embodiment 16

The metal of embodiment 15, wherein said metal is selected from a group consisting of zinc, steel, hot-dip galvanized (HDG) metals, preferably a group consisting of hot-dip galvanized (HDG) steel, electrolytically galvanized metals, alloy electrogalvanized metals and alloy hot-dip galvanized metals.

### Embodiment 17

An article containing a metal of any one of embodiments 15 to 16.

### Embodiment 18

The article of embodiment 17, wherein said metal is at least one selected from a group consisting of zinc, steel, hot-dip galvanized (HDG) metals, preferably hot-dip galvanized (HDG) steel, electrolytically galvanized metals, alloy electrogalvanized metals and alloy hot-dip galvanized metals.

### Embodiment 19

A process of passivating a metallic surface, comprising the step of applying the aqueous non-Cr passivating composition of any one of embodiments 1 to 13 onto the metallic surface.

### EXAMPLES

The present invention will be better understood in view of the following non-limiting examples. The examples do not limit the scope of the invention as described and claimed.

### Metal Substrate Used in the Examples

The metal substrate used in examples is a steel (0A5L72A, A653M/CS TYPE B) commercially available from YIEH PHUI (CHINA) TECHNOMATERIAL CO., LTD. Taiwan, China.

### Passivation of Metal Substrate

To obtain samples for testing, the metal substrate is treated with a non-Cr passivating composition by a process comprising:
a) cleaning the metallic surfaces of a metal substrate with a degreaser (50° C., 1 wt % aqueous solution of Gardoclean® S5185 commercially available from Chemetall, Shanghai, China) at 50° C. for 5 to 10 seconds to remove grease, and rinsing the metal substrate with deionized water until a continuous water film is formed, and subsequently drying the metallic surfaces with hot air; and
b) applying a non-Cr passivating composition onto the degreased surfaces of the metal substrate by a bar applicator, and placing the coated metal substrate in an oven under 280° C. for 5 to 10 seconds to form a non-Cr passivation layer in an amount of 1.0 g/m².

Materials used in examples of this invention are listed in Table A.

TABLE A

| Material | | Description |
|---|---|---|
| Aminosilane | | 3-aminopropyltriethoxysilane |
| Epoxysilane | | 3-epoxypropyl trimethoxysilane |
| Orthosilicate | | Tetraethyl orthosilicate |
| Vinyl silane | | 3-vinyl trimethoxysilane |
| BYK3560 | | Surfactant containing no silicone and fluorine, |
| | | branched, commercially available from BYK |
| | | Chemie, Wesel, Germany |
| BYK-3565 | | Macromer-modified polyacrylate, linear, containing |
| | | no silicone, commercially available from BYK |
| | | Chemie, Wesel, Germany |
| Polyacrylate | NeoCryl XK350, | Emulsion, Mn: 150,000 to 200,000, particle size: |
| resins | solid content 42.5% | 250-300 nm, commercially available from DSM |
| | | NeoResins, Netherlands |
| | PRINTEC ®AH296, | Dispersion, Mn: <10,000, particle size: <100 nm, |
| | solid content 45% | Commercially available from Shanghai Tuxin chemical |
| | | Co., Ltd, Shanghai, China |
| | SYNTRAN ®6305, | Dispersion, Mn: <10,000, particle size: <100 nm, |
| | solid content 35% | Commercially available from Interpolymer, Shanghai, |
| | | China |
| | GUANGSHU ®GS-406, | Emulsion, Mn: 150,000 to 200,000, particle size: |
| | solid content 45% | approximately 100-150 nm, commercially available |
| | | from Changzhou Guangshu Chemical Technology, |
| | | Jiangsu, China |
| | Capast ®CP 7012, | Emulsion, Mn: 150,000 to 200,000, particle size: |
| | solid content 40% | approximately 150-200 nm, commercially available |
| | | from Caprol Chemical (Shanghai) Co., Ltd. Shanghai, |
| | | China |
| | Gardobond PC8918 CA, | Emulsion, Mn: 150,000 to 200,000, particle size: |
| | solid content 33% | approximately 150-200 nm, commercially available |
| | | from Chemetall, Shanghai, China |
| Polyurethane | Siwo ®PUD1917, | Commercially available from Shanghai Sisheng Polymer |
| resins | solid content 30% | Materials Co., Ltd, Shanghai, China |
| | ALBERDINGK ® | Commercially available from Alberdingk Boley, Krefeld, |
| | CUD4820 VP, | Germany |
| | solid content 35% | |
| | ALBERDINGK ® | Commercially available from Alberdingk Boley, Krefeld, |
| | CUD4835 VP, | Germany |
| | solid content 35% | |
| | ESACOTE ®PUC1, | Commercially available from Lamberti Asia Pacific |
| | solid content 30% | Limited, Hong Kong, China |
| | DIC ®HYDRAN | Commercially available from DIC Corporation, Osaka, |
| | MC1030, | Japan |
| | solid content 25% | |
| | DIC ®HYDRAN | Commercially available from DIC Corporation, Osaka, |
| | CP-7520, | Japan |
| | solid content 25% | |
| | DIC ®HYDRAN | Commercially available from DIC Corporation, Osaka, |
| | CP-7050, | Japan |
| | solid content 25% | |

| | |
|---|---|
| Component (c) | 1-hydroxyethane-1,1-diphosphonic acid (HEDP) |
| | Zinc dihydrogen phosphate |
| | Hexafluorotitanic acid |
| | Hexafluorozirconic acid |
| Humectant | SF104E, commercially available from Evonik, |
| | Shanghai, China |
| Defoaming agent | BYK028, commercially available from BYK |
| | Chemie, Wesel, Germany |
| Film-forming aid | Dipropylene glycol mono butyl ether |
| PRINTEC ®PIC BL-W302, hydrophilic | Commercially available from Shanghai Tuxin |
| blocked polyisocynate, deblocking | chemical Co., Ltd, Shanghai, China |
| temp: 90° C. | |
| Siwo Chem ®FB-15, hydrophilic | Commercially available from SiwoChem, |
| blocked polyisocynate, deblocking | Shanghai, China. |
| temp: 100° C. | |
| Lamberti ®BK0, hydrophilic | Commercially available from Lamberti Group, |
| blocked polyisocynate, deblocking | Gallarate, Italy |
| temp: 110° C. | |

### Performance Test

Properties of a non-Cr passivating composition and of the formed passivation layer will be tested as follows.

### <Storage Stability>

Storage stability is evaluated as follows:
placing the prepared composition in a container in an oven of 40° ° C. for 30 days, and then observing the appearance of the composition visually.

Results are rated as follows:
Y (means stable): no obvious precipitate at the bottom of the container
N (means not stable): Otherwise

### <Surface Energy>

Dyne value is used to measure surface energy. After a non-Cr passivating composition is applied, the dyne value of the formed non-Cr passivation layer will be gradually decreased over time. Dyne value of a non-Cr passivation layer is measured by a dyne pen at room temperature (5-40° C.) under 1 atm. with a relative humidity of 50%.

### <Corrosion Resistance>

Corrosion resistance is evaluated by neural salt spraying test (NSST)method according to GB/T 10125-2012 for 96 hours.

Results are rated as follows:
◯ (means meeting the requirement): White rust area<5%;
X (means not meeting the requirement): Otherwise

### <Boiling Water Resistance>

Boiling water resistance is evaluated as follows:
preparing a piece of a sample of a passivated metal substrate having a size of 50 mm*150 mm;
measuring the parameters L, a and b of the center of the piece by HunterLab UltraScan Spectrophotometer;
putting the piece into boiling deionized water, and taking out the piece after 1 hour; and
drying and cooling the piece, followed by measuring the parameters L, a and b of the center of the piece by HunterLab UltraScan Spectrophotometer, to determine ΔE value. ΔE means a color difference of the passivation layer before and after surface treatment that is calculated according to Formula:

$$Δ {E}_{ab}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

Results are rated as follows:
◯ (means meeting the requirement): ΔE≤3
X (means not meeting the requirement): Otherwise

### <Darkening Resistance>

Darkening resistance is evaluated as follows:
preparing a piece of a sample of a passivated metal substrate having a size of 50 mm*100 mm; measuring the parameters L, a and b of the center of the piece by HunterLab UltraScan Spectrophotometer; and
placing the piece vertically in a chamber having a constant temperature and humidity at 50° C. and 98% relative humidity for 120 hours, by sticking the back of the piece to the chamber with an adhesive tape, then measuring the parameters L, a and b of the center of the piece by HunterLab UltraScan Spectrophotometer, to determine ΔE value.

Results are rated as follows:
◯ (means meeting the requirement): ΔE≤3 and White rust area≤5%;
X (means not meeting the requirement): Otherwise

### <Heat Resistance>

Heat resistance is evaluated as follows:
preparing a piece of a sample of a passivated metal substrate having a size of 50 mm*100 mm;
measuring the parameters L, a and b of the center of the piece by HunterLab UltraScan Spectrophotometer;
putting the piece into an oven of 240° C. for 20 min; and then taking the piece out and cooling it to the room temperature (5-40° C.), followed by measuring the parameters L, a and b of the center of the piece by HunterLab UltraScan Spectrophotometer, to determine ΔE value.

Results are rated as follows:
◯ (means meeting the requirement): ΔE≤3
X (means not meeting the requirement): Otherwise

### <Solvent Resistance>

Solvent resistance is evaluated as follows:
preparing a piece of a sample of a passivated metal substrate having a size of 50 mm*100 mm;
measuring the parameters L, a and b of the center of the piece by HunterLab UltraScan Spectrophotometer; and
using a ϕ10 mm cotton yarn stick impregnated with ethanol of 80% concentration, to wipe the piece at an angle of 45° and a pressure of 500 g for 30 times, followed by measuring the parameters L, a and b of the center of the piece by HunterLab UltraScan Spectrophotometer, to determine ΔE value.

Results are rated as follows:
◯ (means meeting the requirement): ΔE≤3
X (means not meeting the requirement): Otherwise

### <Alkali Resistance>

Alkali resistance is evaluated as follows:
preparing a piece of a sample of a passivated metal substrate having a size of 50 mm*150 mm;
measuring the thickness of the passivation layer, by an infrared film-thickness tester; and
heating a degreasing agent (an aqueous solution containing 2 wt % Gardoclean® S 5345 commercially available from Chemetall, Shanghai, China and 0.1 wt % NaOH, PH=12) to a temperature of 50° C., immersing the lower part of the piece into the degreasing agent, extracting for 10 min with an ultrasonic extraction apparatus, then taking out the piece, washing and drying, followed by measuring the thickness of the passivation layer to determine the change of the thickness of the passivation layer.

Results are rated as follows:
◯ (means meeting the requirement): The change of the thickness≤10%
X (means not meeting the requirement): Otherwise

### <Melting Point (MP) and Particle Size>

Melting point is measured under 1 atm.

Particle size is measured according to DLS (dynamic light scattering).

### Example 1: Passivating Composition Comprising Macromer-Modified Polyacrylate

A basic passivating composition is prepared according to the formulations in table 1. A series of compositions are prepared by adding polyether macromer-modified polyacrylates BYK3560 & BYK3565 to the basic passivating composition respectively with the amounts list in table 2. Each composition is used for carrying out the performance tests, and the test results are summarized in table 2.

TABLE 1

| | | Weight |
|---|---|---|
| Component | | Percentage (%) |
| Component (a) | Aminosilane | 2.5 |
| | Epoxysilane | 5 |
| | Orthosilicate | 2.5 |
| | Vinyl silane | 1.5 |
| Component (b) | SYNTRAN ®6305 | 13 |
| | NeoCryl XK350 | 1 |
| | Siwo ®PUD1917 | 5 |
| Component (c) | 1-hydroxyethane-1,1-diphosphonic | 0.3 |
| | acid (HEDP) | |
| | Zinc dihydrogen phosphate | 0.6 |
| | Hexafluorotitanic acid | 0.6 |
| Component (d) | Humectant | 1.8 |
| | Defoaming agent | 0.05 |
| | Film-forming aid | 0.15 |
| | Ultralube ®E1088 | 1.5 |
| Balance | Pure water | 64.5 |
| Total | Weight % | 100 |

TABLE 2

| | Composition | | | | |
|---|---|---|---|---|---|
| | 1 | 2 | 3 | 4 | 5 |
| Components | | | | | |
| Basic passivating | 100 | 99 | 98.5 | 98 | 99 |
| composition, wt % | | | | | |
| BYK3560*, wt % | — | 1 | 1.5 | 2 | — |
| BYK3565, wt % | — | — | — | — | 1 |
| Performance Tests | | | | | |
| Stable (Y/N) | Y | Y | Y | Y | N |
| Dyne value (7 days*) | 38 | 36 | 36 | 36 | — |

| | | | |
|---|---|---|---|
| Remark | — | shrinkage occurred in wet | sediment |
| | | coating/unsatisfactory | occurred |
| | | smell after drying | |

*“7 days” means that the Dyne value was measured 7 days after the application of the composition.
*Introduction of BYK 3560 also causes some negative effect such as lower wetting capability and bad smell.

### Example 2: Passivating Composition Comprising Hydrophilic Blocked Polyisocyanate

The basic passivating composition is prepared according to the formulations in table 1. A series of compositions are prepared by adding hydrophilic blocked polyisocyanates PRINTEC®PIC BL-W302, Siwo Chem®FB-15, and Lamberti®BKO to the basic passivating composition respectively with the amounts list in table 3. Each composition is used for carrying out the performance tests and the test results are summarized in table 3.

TABLE 3

Composition

| | 1 | 2 | 3 | 4 |
|---|---|---|---|---|
| Components | | | | |
| Basic passivating composition, wt % | 100 | 98 | 98 | 98 |
| PRINTEC ®PIC BL-W302 , wt % | — | 2 | — | — |
| Siwo Chem ®FB-15, wt % | — | — | 2 | — |
| Lamberti ®BK0, wt % | — | — | — | 2 |
| Performance Tests | | | | |
| Stable (Y/N) | Y | Y | Y | Y |
| Dyne value (30 days*) | 36 | 40 | 40 | 38 |
| Corrosion resistance | ◯ | ◯ | ◯ | ◯ |
| Boiling water resistance | ◯ | X | X | X |
| Darkening resistance | ◯ | ◯ | ◯ | ◯ |
| Heat resistance | ◯ | ◯ | ◯ | ◯ |
| Solvent resistance | ◯ | ◯ | ◯ | ◯ |

*“30 days” means that the Dyne value was measured 30 days after the application of the composition.

Introduction of hydrophilic blocked polyisocyanate is favorable to increase surface energy. However, introduction of hydrophilic blocked polyisocyanate also causes negative impact on boiling water resistance.

### Example 3

A series of aqueous non-Cr passivating compositions of the present invention are prepared according to the formulations presented in table 4. Each composition is used for carrying out the performance tests and the test results are summarized in table 4.

TABLE 4

| | | Composition (wt %) | | | | | | |
|---|---|---|---|---|---|---|---|---|
| Component | | 1 | 2 | 3 | 4 | 5 | 6 | 7 |
| (a) | Aminosilane | 2.5 | 2.5 | 2.5 | 2.5 | 2.5 | 2.5 | 2.5 |
| | Epoxysilane | 5 | 5 | 5 | 5 | 5 | 5 | 5 |
| | Orthosilicate | 2.5 | 2.5 | 2.5 | 2.5 | 2.5 | 2.5 | 2.5 |
| | Vinyl silane | 1.5 | 1.5 | 1.5 | 1.5 | 1.5 | 1.5 | 1.5 |
| (b) | SYNTRAN ®6305 | 10 | 10 | 10 | 10 | 10 | 10 | 10 |
| | NeoCryl XK350 | 1 | 1 | 1 | 1 | 1 | 1 | 1 |
| | Siwo ®PUD1917 | 9 | — | — | — | — | — | — |
| | ALBERDINGK ®CUD4820 VP | — | 8 | — | — | — | — | — |
| | ALBERDINGK ®CUD4835 VP | — | — | 8 | — | — | — | — |
| | ESACOTE ®PUC1 | — | — | — | 9 | — | — | — |
| | DIC ®HYDRAN MC1030 | — | — | — | — | 11 | — | — |
| | DIC ®HYDRAN CP-7520 | — | — | — | — | — | 11 | — |
| | DIC ®HYDRAN CP-7050 | — | — | — | — | — | — | 11 |
| (c) | 1-hydroxyethane-1,1- | 0.3 | 0.3 | 0.3 | 0.3 | 0.3 | 0.3 | 0.3 |
| | diphosphonic acid (HEDP) | | | | | | | |
| | Zinc dihydrogen phosphate | 0.6 | 0.6 | 0.6 | 0.6 | 0.6 | 0.6 | 0.6 |
| | Hexafluorotitanic acid | 0.6 | 0.6 | 0.6 | 0.6 | 0.6 | 0.6 | 0.6 |
| (d) | Humectant | 1.8 | 1.8 | 1.8 | 1.8 | 1.8 | 1.8 | 1.8 |
| | Defoaming agent | 0.05 | 0.05 | 0.05 | 0.05 | 0.05 | 0.05 | 0.05 |
| | Film-forming aid | 0.15 | 0.15 | 0.15 | 0.15 | 10.15 | 0.15 | 0.15 |
| | Ultralube ®E1088 | 1.5 | 1.5 | 1.5 | 1.5 | 1.5 | 1.5 | 1.5 |
| Balance | Water | 63.5 | 64.5 | 64.5 | 63.5 | 61.5 | 61.5 | 61.5 |
| Total | Weight % | 100 | 100 | 100 | 100 | 100 | 100 | 100 |

| | Component | | | | | | |
|---|---|---|---|---|---|---|---|
| Performance Tests | 1 | 2 | 3 | 4 | 5 | 6 | 7 |
| Stable (Y/N) | Y | Y | Y | Y | Y | Y | Y |
| Dyne value (30 days*) | 40 | | | | | | |
| Corrosion resistance | ◯ | ◯ | ◯ | ◯ | ◯ | ◯ | ◯ |
| Boiling water resistance | ◯ | ◯ | ◯ | ◯ | ◯ | ◯ | ◯ |
| Darkening resistance | ◯ | ◯ | ◯ | ◯ | ◯ | ◯ | ◯ |
| Heat resistance | ◯ | ◯ | ◯ | ◯ | ◯ | ◯ | ◯ |
| Solvent resistance | ◯ | ◯ | ◯ | ◯ | ◯ | ◯ | ◯ |

*“30 days” means that the Dyne value was measured 30 days after the application of the composition.

### Example 4

Another series of aqueous non-Cr passivating compositions of the present invention are prepared according to the formulations in table 5. Each composition is used for carrying out the performance tests and the test results are summarized in table 5.

TABLE 5

| | | Composition (wt %) | | | | | | | | | |
|---|---|---|---|---|---|---|---|---|---|---|---|
| Component | | 1 | 2 | 3 | 4 | 5 | 6 | 7 | 8 | 9 | 10 |
| (a) | Aminosilane | 2.5 | 2.5 | 2.5 | 2.5 | 2.5 | 2.5 | 2.5 | 2.5 | 2.5 | 2.5 |
| | Epoxysilane | 5 | 5 | 5 | 5 | 5 | 5 | 5 | 5 | 5 | 5 |
| | Orthosilicate | 2.5 | 2.5 | 2.5 | 2.5 | 2.5 | 2.5 | 2.5 | 2.5 | 2.5 | 2.5 |
| | Vinyl silane | 1.5 | 1.5 | 1.5 | 1.5 | 1.5 | 1.5 | 1.5 | 1.5 | 1.5 | 1.5 |
| (b) | Siwo ®PUD1917 | 9 | 9 | 9 | 9 | 9 | — | — | — | — | — |
| | ALBERDINGK ®CUD4835 VP | — | — | — | — | — | 8 | 8 | 8 | 8 | 8 |
| | PRINTEC ®AH296 | 8 | — | — | — | — | 8 | — | — | — | — |
| | SYNTRAN ®6305 | — | 10 | — | — | — | — | 10 | — | — | — |
| | GUANGSHU ®GS-406 | — | — | 8 | — | — | — | — | 8 | — | — |
| | Capast ®CP 7012 | — | — | — | 9 | — | — | — | — | 9 | — |
| | Gardobond PC8918 CA | — | — | — | — | 11 | — | — | — | — | 11 |
| | NeoCryl XK350 | 1 | 1 | 1 | 1 | 1 | 1 | 1 | 1 | 1 | 1 |
| (c) | 1-hydroxyethane-1,1- | 0.3 | 0.3 | 0.3 | 0.3 | 0.3 | 0.3 | 0.3 | 0.3 | 0.3 | 0.3 |
| | diphosphonic acid (HEDP) | | | | | | | | | | |
| | Zinc dihydrogen phosphate | 0.6 | 0.6 | 0.6 | 0.6 | 0.6 | 0.6 | 0.6 | 0.6 | 0.6 | 0.6 |
| | Hexafluorotitanic acid | 0.6 | 0.6 | 0.6 | 0.6 | 0.6 | 0.6 | 0.6 | 0.6 | 0.6 | 0.6 |
| (d) | Humectant | 1.8 | 1.8 | 1.8 | 1.8 | 1.8 | 1.8 | 1.8 | 1.8 | 1.8 | 1.8 |
| | Defoaming agent | 0.05 | 0.05 | 10.05 | 0.05 | 0.05 | 0.05 | 0.05 | 0.05 | 0.05 | 0.05 |
| | Film-forming aid | 0.15 | 0.15 | 0.15 | 0.15 | 0.15 | 0.15 | 0.15 | 0.15 | 0.15 | 0.15 |
| | Ultralube ®E1088 | 1.5 | 1.5 | 1.5 | 1.5 | 1.5 | 1.5 | 1.5 | 1.5 | 1.5 | 1.5 |
| balance | Water | 65.5 | 63.5 | 65.5 | 64.5 | 62.5 | 66.5 | 64.5 | 66.5 | 65.5 | 63.5 |
| total | Weight % | 100 | 100 | 100 | 100 | 100 | 100 | 100 | 100 | 100 | 100 |

Composition

| Performance Tests | 1 | 2 | 3 | 4 | 5 | 6 | 7 | 8 | 9 | 10 |
|---|---|---|---|---|---|---|---|---|---|---|
| Stable (Y/N) | Y | Y | Y | Y | Y | Y | Y | Y | Y | Y |

| | |
|---|---|
| Dyne value (*30 days) | 40 |

| | | | | | | | | | | |
|---|---|---|---|---|---|---|---|---|---|---|
| Corrosion resistance | ◯ | ◯ | ◯ | ◯ | ◯ | ◯ | ◯ | ◯ | ◯ | ◯ |
| Boiling water resistance | ◯ | ◯ | ◯ | ◯ | ◯ | ◯ | ◯ | ◯ | ◯ | ◯ |
| Darkening resistance | ◯ | ◯ | ◯ | ◯ | ◯ | ◯ | ◯ | ◯ | ◯ | ◯ |
| Heat resistance | ◯ | ◯ | ◯ | ◯ | ◯ | ◯ | ◯ | ◯ | ◯ | ◯ |
| Solvent resistance | ◯ | ◯ | ◯ | ◯ | ◯ | ◯ | ◯ | ◯ | ◯ | ◯ |
| Alkali resistance | X | X | ◯ | ◯ | ◯ | X | X | ◯ | ◯ | ◯ |

*“30 days” means that the Dyne value was measured 30 days after the application of the composition.

1. An aqueous non-Cr passivating composition comprising
(a) from 5% to 20% by weight of a silicon-containing compound; and
(b) from 5% to 15% by weight of a water-borne polymer selected from a group consisting of polyurethane resin, epoxy resin, polyacrylate resin and the combination thereof, the weight percentage is based on the total weight of the non-Cr passivating composition.

2. The aqueous non-Cr passivating composition of claim 1, wherein said component (b) is a combination of polyurethane resin and polyacrylate resin.

3. The aqueous non-Cr passivating composition of claim 1, wherein said silicon-containing compound is selected from the group consisting of silanes and silica sols.

4. The aqueous non-Cr passivating composition of claim 3, wherein said silica sol has an average particle diameter in a range of from 5 nm to 100 nm.

5. The aqueous non-Cr passivating composition of claim 3, wherein said silica sol is in a form of dispersion having a concentration of from 10% to 50% by weight based on the total weight of the dispersion.

6. The aqueous non-Cr passivating composition of claim 1, wherein said polyurethane resin does not contain an aromatic group.

7. The aqueous non-Cr passivating composition of claim 1, wherein it further comprises (c): from 1% to 10% by weight of a corrosion inhibitor, wherein the weight percentage is based on the total weight of the non-Cr passivating composition.

8. The aqueous non-Cr passivating composition of claim 7, wherein said corrosion inhibitor is at least one selected from the group consisting of phosphorus-containing compounds and acidic corrosion inhibitors.

9. The aqueous non-Cr passivating composition of claim 1, wherein it further comprises (d): from 1% to 10% by weight of an additive selected from the group consisting of defoaming agent, humectant and film-forming aid.

10. The aqueous non-Cr passivating composition of claim 1, wherein said polyacrylate resin has a number average molecular weight in a range of from 100,000 Dalton to 500,000 Dalton, determined by gel permeation chromatography according to DIN 55672-1.

11. The aqueous non-Cr passivating composition of claim 1, wherein said polyacrylate resin has an average particle diameter in a range of from 50 nm to 400 nm measured by dynamic light scattering.

12. The aqueous non-Cr passivating composition of claim 1, wherein said component (b) is a combination of polyurethane resin and polyacrylate resin; said polyacrylate resin has a number average molecular weight in a range of from 100,000 Dalton to 500,000 Dalton, determined by gel permeation chromatography according to DIN 55672-1 and said polyacrylate resin has an average particle diameter in a range of from 50 nm to 400 nm measured by dynamic light scattering.

13. The aqueous non-Cr passivating composition of claim 1, wherein said polyacrylate resin is synthesized by emulsion polymerization.

14. A passivation layer obtained from the aqueous non-Cr passivating composition of claim 1.

15. A metal with a surface passivated by the aqueous non-Cr passivating composition of claim 1.

16. The metal of claim 15, wherein said metal is selected from the group consisting of zinc, steel, and hot-dip galvanized (HDG) metals.

17. An article containing the metal of claim 15.

18. The article of claim 17, wherein said metal is at least one selected from the group consisting of zinc, steel, and hot-dip galvanized (HDG) metals.

19. A process of passivating a metallic surface, comprising a step of applying the aqueous non-Cr passivating composition of claim 1 onto the metallic surface.

20. The aqueous non-Cr passivating composition of claim 1, comprising
(a) from 8% to 15% by weight of a silicon-containing compound; and
(b) from 5% to 10% by weight of a water-borne polymer selected from the group consisting of polyurethane resin, epoxy resin, polyacrylate resin and the combination thereof, wherein the weight percentage is based on the total weight of the non-Cr passivating composition.
